(19) United States
(12) Patent Application Publication
(10) Pub. No.: US 2006/0209224 A1
(43) Pub. Date: Sep. 21, 2006

(54) Display device and manufacturing method of the same

(75) Inventor: Norio Nakanishi, Chiba (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/346,307

(22) Filed: Feb. 3, 2006

(30) Foreign Application Priority Data
Mar. 18, 2005 (JP) 2005-080032

(51) Int. Cl. B23K 26/38; G02F 1/1333

(52) U.S. Cl. 349/56; 219/121.72

(57) ABSTRACT

The present invention provides a display device and a manufacturing method of the display device which can reduce the breaking of a glass substrate attributed to fine cracks by combining a scribe-and-break method and a laser cutting method. Out of a pair of substrates, one substrate is mechanically scribed and another substrate is cut using a laser beam.

The present application claims priority from Japanese application JP2005-080032 filed on Mar. 18, 2005, the content of which is hereby incorporated by reference into this application.

### BACKGROUND OF THE INVENTION

1. Field of the Invention

The present invention relates to a display device and a manufacturing method of the display device, and more particularly to a display device and a manufacturing method of the display device which can be manufactured by adhering a pair of substrates made of an insulating material such as glass and by dividing a base substrate having a size larger than a size of the display device which is obtained finally.

2. Description of the Related Art

A miniaturized display device for a mobile phone or the like is requested to ensure the strength together with the reduction of thickness. A glass substrate is often used as the substrate. Here, the explanation is made by taking a glass substrate as an example. In reducing the thickness of the display device, there exists a tendency that a plate thickness of the glass substrate is reduced to 0.2 mm from 0.5 mm. For example, with respect to the liquid crystal display device, using such a thin-plate glass as a base substrate, a two-sheet-laminated substrate which having a size which allows the arrangement of a plurality of display devices thereon is manufactured, and the substrate is separated into individual display devices using a mechanical cutting means or laser beams.

The mechanical cutting is a method in which linear grooves (scribe lines) are formed in one surface of the glass substrate using a wheel-like cutter blade (scribe wheel) and, thereafter, a linear cutting blade is pressed to another surface thus dividing the glass substrate into the plurality of display devices along the scribe lines and hence, the method is generally referred to as “scribe and break”. As a conventional example of this method, a technique disclosed in JP-A-2003-131185 (Patent Document 1) is named.

Further, the cutting which uses laser beams is a method in which the laser beams are irradiated to the glass substrate while moving the glass substrate relative to the laser and, at the same time, a cooling wind or a mist is blown off immediately after the laser cutting so as to cut the base substrate. This method, different from the method which uses the scribe wheel, generates no minute cracks on end surfaces (divided peripheries) of the glass substrate. With respect to the division of the glass substrate using the laser beams, a technique disclosed in JP-A-2002-172479 (Patent Document 2) is named.

### SUMMARY OF THE INVENTION

In a liquid crystal display device which is constituted of a TFT substrate and a counter substrate, assuming that the TFT substrate constitutes a lower substrate and the counter substrate constitutes an upper substrate and a load is applied to the liquid crystal display device from the counter substrate side, the lower substrate is deflected more largely and hence, a tensile strength of the lower substrate is increased whereby cracks are liable to easily occur in the lower substrate. Since cracks are liable to easily occur on an end surface of the glass substrate in the mechanical scribing, when the glass substrate is deflected, the substrate is liable to be easily broken due to a tensile strength. Accordingly, when the thickness of the substrate is reduced, the substrate cannot ensure the strength. With respect to the method which uses laser beams, cracks hardly occur on the end surface (divided periphery) of the glass substrate and hence, the substrate can ensure the strength. However, the laser facility incurs a higher installation cost compared to the mechanical scribing device.

Further, when the mechanical scribing device is used, it is necessary to turn over the glass substrate. The thinner the glass substrate becomes or the larger the size of the substrate becomes, the turn-over of the substrate becomes more difficult. Here, when the glass substrate is not turned over, it is necessary to provide a laser device on front and rear surfaces thereof respectively. Further, in the cutting operation which requires the laser beams, when a film made of ITO or the like is formed on the outer surface of the substrate, the cutting becomes difficult.

It is an advantage of the present invention to provide a display device and a manufacturing method thereof which can reduce the occurrence of breaking of a glass substrate attributed to fine cracks by combining a scribe-and-break method and a laser cutting method.

The gist of the present invention lies in that one substrate is cut by a laser method and another substrate is cut by a mechanical scribe-and-break method. On end surfaces of substrates of the individual separated liquid crystal display devices, a trace which enables the recognition whether the substrate is cut by the laser or the mechanical means remains.

To describe the typical constitutions of the present invention, they are as follows. First of all, with respect to the display device, following constitutions are provided.

(1) A pair of substrates which constitutes a display device is obtained from a base substrate having a size larger than a size of the display device which is finally obtained.

Out of the pair of substrates, a divided periphery of one substrate bears a trace which is formed by mechanical scribing and a divided periphery of another substrate bears a trace which is formed by cutting using a laser beam.

(2) It is desirable that a film such as a transparent conductive film is formed on an outer surface (for example, a viewer side) of one substrate, a divided periphery of the one substrate bears a trace which is formed by mechanical scribing and a divided periphery of another substrate bears a trace which is formed by cutting using a laser beam.

Further, with respect to the manufacturing method of the display device, the following constitution is provided.

(3) In the above-mentioned pair of substrates, one substrate is broken after the mechanical scribing, and another substrate is cut using a laser beam thus dividing the substrates into the individual display device size. Here, the cutting of the another substrate using the laser beam is performed without turning over the pair of substrates or by turning over the pair of substrates. Further, the one substrate is broken mechanically or using a laser beam.

Further, as another example of the manufacturing method of the display device, the following constitution is provided.

(4) In a manufacturing method of a display device which includes one substrate and another substrate which face each other in an opposed manner,

a film is formed on an outer surface of one substrate which constitutes a surface on a side opposite to a surface of the one substrate which faces another substrate in an opposed manner,

mechanical scribing is applied to the one substrate from above the film formed on the outer surface, and

cutting using a laser beam is applied to the another substrate.

In the constitutions (1) to (4), when the display device is constituted of the pair of laminated substrates, wherein one substrate is a TFT substrate and another substrate is a counter substrate, it is desirable to use a thin film transistor (also referred to as TFT hereinafter) substrate as a lower substrate and the counter substrate as an upper substrate, to cut the lower substrate by a laser method, and to cut the upper substrate by a scribe-and-break method. When the counter substrate side requires the strength, it is desirable to cut the counter substrate by a laser method. When a film made of ITO or the like is formed on the outer surface of the substrate, the film may be patterned by etching or the like so as to remove the film at cut portions and, thereafter, the substrate is cut by a laser method. Alternatively, a first laser having a wavelength which is absorbed in the film may be used for removing the film, and a second laser having a wavelength which is absorbed in the substrate may be used for cutting. Here, the cutting or the separation of the lower substrate and the upper substrate may be performed simultaneously or either one of the lower substrate and the upper substrate may be cut or separated first.

According to the present invention, with the use of the laser beams in cutting the substrate on the side which requires the strength, it is possible to maintain the strength of the whole display device. Since the turn-over operation of the substrates is not always necessary, it is possible to simplify the facility. Even when the film is formed on the outer surface of the substrate and the cutting using the laser beams is difficult, it is possible to cut the substrate.

### BRIEF DESCRIPTION OF THE DRAWINGS

FIG. 1A and FIG. 1B are appearance views showing one example of a mobile phone which uses a liquid crystal display device in a display part, wherein FIG. 1A is a front view and FIG. 1B is a side view;

FIG. 2 is a schematic view for explaining a stress when a load is applied to the liquid crystal display device;

FIG. 3 is a schematic view for explaining a manner of operation in which scribe lines for dividing a base substrate into the individual liquid crystal display devices are mechanically formed using a scribe wheel;

FIG. 4 is a view for explaining a manner of operation in which the base substrate is divided into the individual liquid crystal display devices using a breaking blade after forming the scribe lines;

FIG. 5 is a view for explaining the manner of operation in which the base substrate is divided into individual liquid crystal display devices using the laser;

FIG. 6 is a chart in which a result of a comparison among the hybrid cutting of the present invention, a conventional scribe-and-break method, and the cutting using only laser beams is shown; and

FIG. 7 is a chart in which the detail of the hybrid cutting of the present invention is summed up.

### DESCRIPTION OF THE PREFERRED EMBODIMENTS

Hereinafter, specific embodiments for carrying out the present invention are explained in conjunction with attached drawings which show embodiments, wherein the substrate constitution of a display device and the division of the substrate constitution are explained firstly. Here, although the explanation will be made with respect to an example in which the display device is constituted of a liquid crystal display device, the present invention is also applicable to other similar display devices in the same manner.

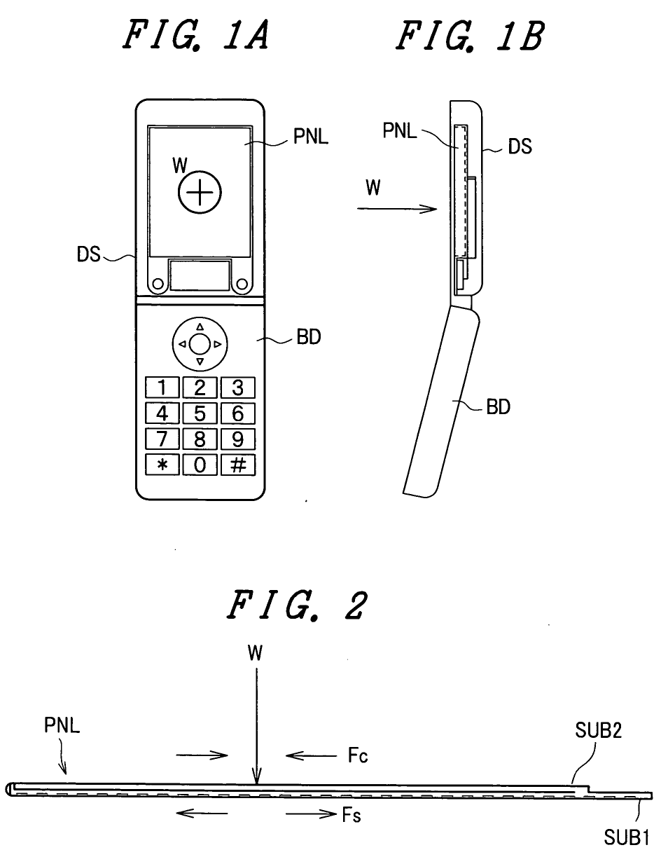

FIG. 1A and FIG. 1B are appearance views showing an example of a mobile phone which uses a liquid crystal display device in a display part. The mobile phone includes a body part BD and a display part DS, wherein the display part DS is configured to be foldable to the body part BD. A liquid crystal display device PNL is mounted on the display part DS. With respect to the liquid crystal display device which is mounted in this manner, it is often the case that a load W is applied in the direction indicated in the drawing during the use thereof.

FIG. 2 is a schematic view for explaining stresses when the load W is applied to the liquid crystal display device PNL. A liquid crystal display device PNL is, usually, constituted by laminating a glass substrate (TFT substrate) SUB1 on which pixels having thin film transistors and the like are formed and a counter substrate SUB2 which faces the glass substrate SUB1 in an opposed manner as a pair. Further, usually, the mounting of the liquid crystal display device is performed in a state that the counter substrate SUB2 side is exposed to a front side as a viewing screen.

When the load W shown in FIG. 1 is applied to the counter substrate SUB2 side, around a point to which the load W is applied, a compressive stress Fc is generated in the counter substrate SUB2, and a tensile stress Fs is generated in the TFT substrate SUB1. Since the glass substrate is weak against the tensile stress, cracks are liable to easily occur on a back side thereof at the point to which the load W is applied. Particularly, when the liquid crystal display device PNL has a rectangular shape, the stress is concentrated mostly on end surfaces of long sides thereof and cracks are liable to easily occur in the end surfaces.

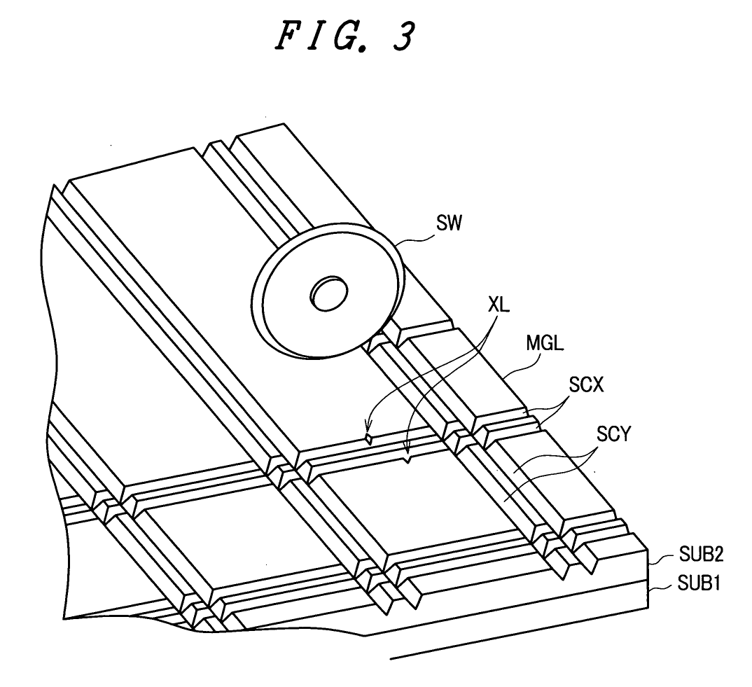

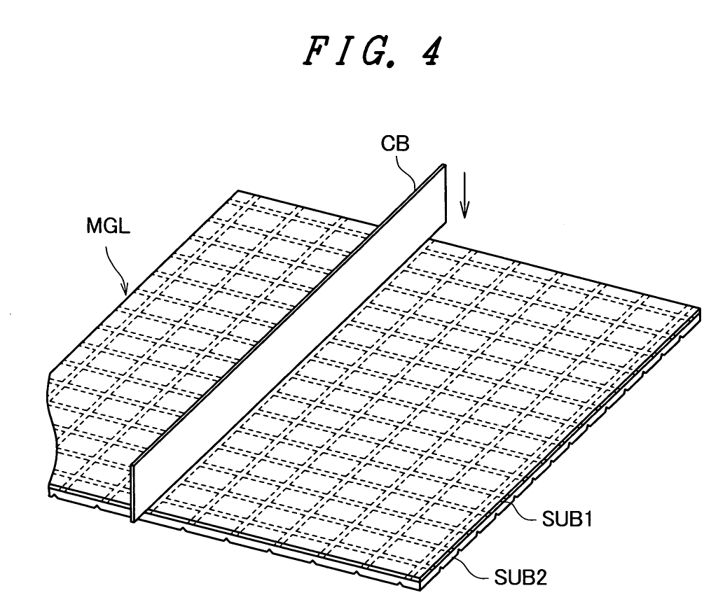

FIG. 3 is a view for explaining the manner of operation for mechanically forming scribe lines for dividing a base substrate into the individual liquid crystal display devices using a scribe wheel. Further, FIG. 4 is a view for explaining the manner of operation in which the base substrate is divided into the individual liquid crystal display devices using a breaking blade after forming the scribe lines. Here, the base substrate MGL assumes a state in which the TFT substrate and the counter substrate are laminated to each other. In the mechanical dividing, the scribe lines are formed on the glass substrate which constitutes the base substrate MGL and, thereafter, as shown in FIG. 4, the base substrate MGL is turned over, and the breaking blade CB is brought into pressure contact with a surface of the base substrate MGL opposite to a surface on which the scribe lines are formed along the scribe lines thus separating the base substrate MGL into the individual liquid crystal display devices (scribe-and-break).

FIG. 3 shows a state in the course of an operation in which the scribe lines SCY in the first direction are formed on the base substrate MGL using the scribe wheel SW while moving the base substrate MGL in the first direction Y, thereafter, the base substrate MGL is rotated by 90 degrees, and the scribe lines SCX in the second direction are formed in the base substrate MGL along the second direction X.

Here, when the base substrate MGL is separated into the individual liquid crystal display devices using the scribe wheel SW, fine cracks XL occur on the end surfaces of the substrate. The presence of the fine cracks XL makes the substrate weak against the tensile stress and hence, when such fine cracks XL occur, there exists the possibility that the substrate is broken at the time of breaking the base substrate MGL or the substrate is broken due to the load W which is applied to the liquid crystal display device in a state that the liquid crystal display device is mounted on a product which has been explained in conjunction with FIG. 1.

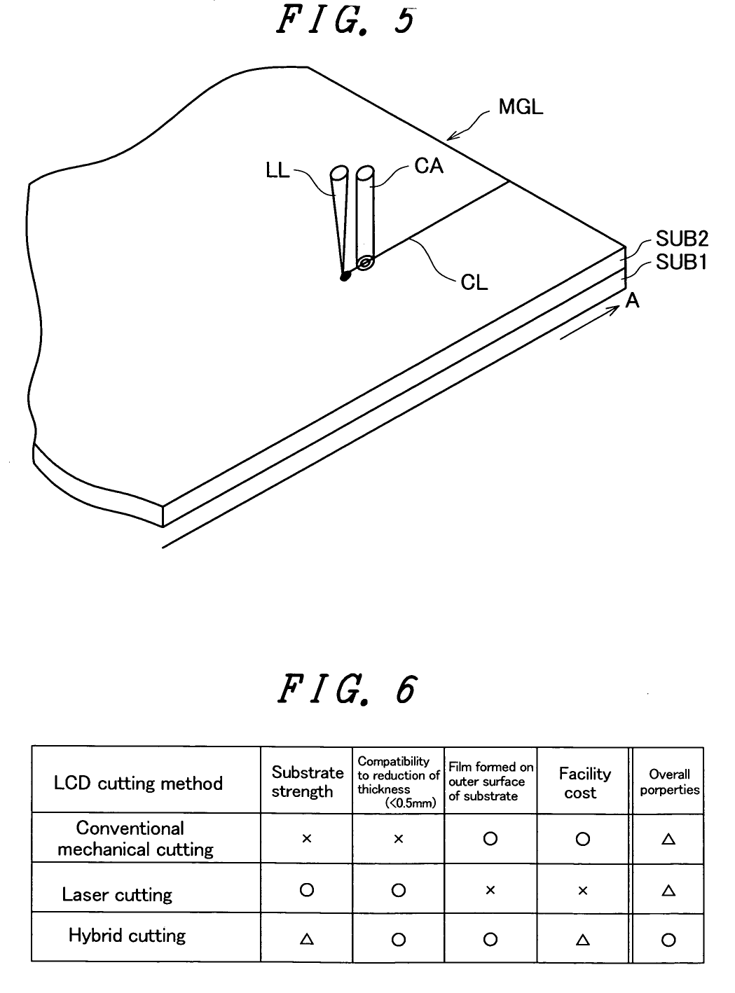

Further, FIG. 5 is a view for explaining the manner of operation in which the base substrate is divided into the individual liquid crystal display devices using the laser. In the cutting using the laser beams, as shown in FIG. 3, while moving the base substrate MGL relative to the laser, laser beams LL are irradiated to the base substrate MGL. By blowing off cold air CA or mist immediately after the irradiation of the laser beams LL, it is possible to cut the base substrate MGL along the cutting line CL. In this method, the fine cracks XL which occur when the scribe wheel is used do not occur on the end surfaces of the substrate. Accordingly, the liquid crystal display device exhibits the sufficient strength against the load W.

Here, FIG. 5 shows an example in which the substrate is cut by irradiating one laser beam LL in a state that the scribe line is not formed. That is, FIG. 5 shows the case in which the scribing and the breaking are simultaneously performed. As a modification of the laser cutting, the scribing and the breaking may be performed separately from each other. In this case, a scribe lines not shown in the drawing are formed using another laser beam not shown in the drawing which precedes the laser beam LL shown in FIG. 5, and the laser beam LL is irradiated to the scribe line and, immediately thereafter, cold wind CA or mist may be blown off to the liquid crystal display device.

### Embodiment 1

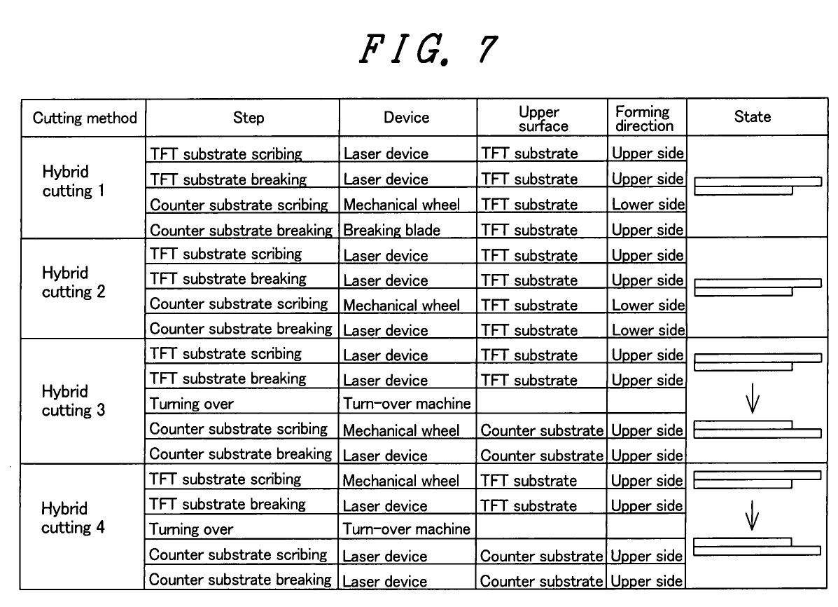

The present invention is characterized by dividing the pair of glass substrates which are laminated to each other in an opposed manner by using the above-mentioned mechanical cutting (scribe-and-break) method and laser cutting method together, and such cutting is referred to as hybrid cutting. FIG. 6 shows a result obtained by comparing cases in which a conventional scribe-and-break method, a conventional cutting using only a laser (division) and the hybrid cutting of the present invention are respectively applied to the cutting of the pair of glass substrates which constitutes the liquid crystal display device (LCD) with respect to the strength of substrate, compatibility to the reduction of thickness of the substrate (to be more specific compatibility to the glass substrate having a thickness of 0.5 mm or less), the compatibility when the film is formed on the outer surface of the substrate, a dividing facility cost, and the overall properties. In FIG. 6, circle indicates “favorable”, triangle indicates “normal”, and x indicates “defective”.

As shown in FIG. 6, it is understood that the hybrid cutting of the present invention is particularly suitable for the reduction of thickness of the substrate, can also provide the favorable cutting of the substrate which forms the film made of ITO or the like on the outer surface thereof, and can also exhibit the favorable overall properties.

Although the hybrid cutting of the present invention is basically “hybrid cutting 1” which does not require the turn-over of the substrate, as modifications of “hybrid cutting 1”, “hybrid cutting 2”, “hybrid cutting 3”, and “hybrid cutting 4” are provided.

FIG. 7 shows the detail of “hybrid cutting 1”, “hybrid cutting 2”, “hybrid cutting 3”, and “hybrid cutting 4” of the present invention.

In FIG. 7, four kinds of hybrid cuttings consisting of the hybrid cutting 1 to the hybrid cutting 4 are listed in a column “cutting method”. A column “step” indicates the name of the step. In a column “device”, the device which is used for forming is indicated. A column “upper surface” indicates either one of the TFT substrate SUB1 and the counter substrate SUB2 which assumes the upper side at the time of forming. A column “forming direction” indicates either one of the upper and lower directions along which the forming is performed. Usually, the device described in the column “device” is arranged on a side described in the column “forming direction” with respect to the base substrate MGL. A column “state” illustrates a state of the base substrate MGL in the column “upper surface”, wherein an arrow indicates the turn-over of the base substrate MGL. Here, in FIG. 7, to assign the priority to the visual understanding, the state after the base substrate MGL is separated into the individual display devices (the structure in which the TFT substrate SUB1 projects from the counter substrate SUB2) is illustrated. Accordingly, the substrate which is actually formed is the base substrate MGL before being separated into respective display device and hence, the TFT substrate SUB1 and the counter substrate SUB2 having the substantially equal size are laminated to each other.

In the hybrid cutting 1, the cutting of the TFT substrate is performed using the laser device, and the cutting of the counter substrate is performed using the mechanical scribe-and-break method. To be more specific, in performing the cutting of the TFT substrate, the cutting is performed by irradiating the laser beams from above in a state that the TFT substrate is arranged on the upper side. Then, in cutting the counter substrate, the counter substrate is cut from below by mechanical scribing using the mechanical wheel, and the breaking of the counter substrate is performed mechanically from above using the breaking blade.

Here, the cutting by the laser and the mechanical cutting may be performed simultaneously or either one of the cutting using the laser beams and the mechanical cutting may be performed firstly. Alternatively, instead of placing the TFT substrate as the upper substrate, the counter substrate may be placed as the upper substrate. Further, the counter substrate may be cut using the laser beams and the TFT substrate may be mechanically cut.

In this embodiment, it is unnecessary to turn over the substrate and hence, a turner is unnecessary. In an attempt to cut both substrates using the laser beams without turning over the substrate, there exists a drawback that two laser devices become necessary thus pushing up a facility cost. However, according to the hybrid cutting 1, one substrate is cut mechanically and hence, even without turning over the substrate, one laser beam device is sufficient and hence, the facility cost can be suppressed.

Further, when both of the TFT substrate and the counter substrate are mechanically cut, the turner becomes necessary. Accordingly, when the thickness of the substrate is reduced or when the base substrate becomes large-sized, it is difficult to turn over the substrate and, in the worst case, there arises a drawback that the substrate is broken when the substrate is turned over. The hybrid cutting 1 can overcome such a drawback.

Here, with respect to the individually separated display devices, there exists the possibility that the fine cracks XL occur on the end surfaces of the substrate to which the mechanical scribing is applied. However, as described previously, the fine cracks XL hardly occur on the end surfaces of the substrate which is cut by the laser. Here, when the load W is applied from a viewer side, the substrate which is liable to be easily broken attributed to the finer cracks XL is a substrate to which the tensile stress Fs is applied, that is, the substrate on the side opposite to the viewer side. Accordingly, by arranging the substrate to which the mechanical scribing is applied on the viewer side and by arranging the substrate which is cut by the laser on the side opposite to the viewer, even when the load W is applied from the viewer side, the substrate is hardly broken thus ensuring the strength of the substrate. The same goes for the hybrid cuttings 2, 3, 4 described later.

Here, in FIG. 7 which explains the hybrid cutting 1 to the hybrid cutting 4, with respect to the cutting using the laser device, the scribing and the breaking are described as steps separate from each other for the sake of convenience. However, two steps consisting of scribing and breaking can be performed together simultaneously using one laser or can be performed separately by preparing the laser for scribing and the laser for breaking.

Although CO₂ laser beams are preferable as the laser beams used for cutting the substrate, YAG laser beams may be also used. Here, when the film is formed on the outer surface of the substrate, there may be the possibility that the laser beams are reflected on the film and hence, the forming of the substrate becomes difficult. For example, in case of an IPS type liquid crystal display device, to cope with static electricity, a transparent conductive film made of ITO or the like is formed on the outer surface of the counter substrate SUB2. However, CO₂ laser beams are reflected on the transparent conductive film made of ITO or the like.

Accordingly, when the film is formed on the outer surface of the substrate, it is possible to overcome the drawback by applying the mechanical scribing in the direction that the film is formed. Here, after applying the mechanical scribing, the substrate may be mechanically broken as in the case of the hybrid cutting 1 or may be broken using the laser beams as in the case of the hybrid cuttings 2, 3 described later. Further, by forming the film on the outer surface of the substrate and by arranging the counter substrate to which the mechanical scribing is applied on the viewer side, it is also possible to ensure the above-mentioned strength of the substrate.

The film formed on the outer surface of the substrate is not limited to the transparent conductive film and may be formed of a reflection preventing film or the like. Further, the formation of the film is not limited to the formation of the film on the counter substrate and the film may be formed on the TFT substrate.

The hybrid cutting 2 differs from the hybrid cutting 1 with respect to a point that the counter substrate is broken using the laser beams. Also in the hybrid cutting 2, it is unnecessary to turn over the substrate. However, the laser beams for breaking the counter substrate must be irradiated from below and hence, two laser devices become necessary thus pushing up the facility cost. However, compared to the case that the mechanical breaking is performed, flaws formed on the end surfaces of the substrate can be reduced and hence, it is possible to ensure the strength of the substrate. Further, since the mechanical scribing is applied, it is possible to perform the forming even when the film is formed on the surface of the substrate.

The hybrid cutting 3 differs form the hybrid cutting 1 with respect to the point that a turner is necessary. Further, in the hybrid cutting 3, the scribing of the counter substrate is mechanically performed from above using the mechanical wheel. Accordingly, it is possible to perform the machining even when the film is formed on the outer surface of the counter substrate. The breaking of the counter substrate is performed from above using the laser. Accordingly, it is possible to ensure the strength of the substrate. Further, since the laser used for cutting the TFT substrate can be also used for cutting the counter substrate, it is sufficient to provide one set of laser device thus suppressing the facility cost.

In the hybrid cutting 4, the TFT substrate is mechanically scribed and, thereafter, is broken using the laser beams. Further, the counter substrate is cut using the laser beams. Since both cuttings are performed from the same side, it is necessary to turnover the substrate. However, it is sufficient to provide one laser device and hence, the facility cost can be suppressed. The hybrid cutting 4 is a method which emphasizes the substrate strength of the counter substrate.

### Embodiment 2

The embodiment 2 is an embodiment directed to a method which cuts the substrate using the laser beams when the film is formed on the outer surface of the substrate. Here, the embodiment 2 may be combined with the hybrid cuttings 1 to 4 of the embodiment 1 and, at the same time, may be combined with the conventional laser cutting which does not use the hybrid cutting.

When the film (for example, ITO film) which is formed on the outer surface of the substrate reflects the laser beams (for example, CO₂ laser beams), there exists a drawback that the cutting using the laser beams is difficult. A following method is provided for overcoming the drawback.

(A) After patterning the film on the outer surface of the substrate, the substrate is cut using the laser beams.

(B) The film formed on the outer surface of the substrate is cut (removed) using the first laser beams (for example, Nd YAG laser beams) and, thereafter, the substrate is cut using the second laser beams (for example, CO₂ laser beams). This is one of variations of (A).

(C) After patterning the film on the outer surface of the substrate by etching, the substrate is cut using the laser beams. This is one of the variations of (A).

(D) After forming a state in which the film is formed by patterning on the outer surface of the substrate by printing or mask sputtering, the substrate is cut using the laser beams. This is one of the variations of (A).

What is claimed is:

1. A display device which is constituted of a pair of substrates which face each other in an opposed manner, wherein
the pair of substrates is obtained by dividing a base substrate having a size larger than a size of the display device which is finally obtained, and
a divided periphery of one substrate out of the pair of substrates bears a trace which is formed by mechanical scribing, and divided periphery of another substrate bears a trace formed by cutting using a laser beam.

2. A display device according to claim 1, wherein a film is formed on an outer surface of the one substrate.

3. A display device according to claim 2, wherein the film formed on the outer surface of the one substrate is a transparent conductive film.

4. A display device according to claim 1, wherein the one substrate is a substrate on a viewer side.

5. A display device according to claim 1, wherein the another substrate is a thin film transistor substrate and the one substrate is a counter substrate.

6. A display device which is constituted of a pair of substrates which face each other in an opposed manner, wherein
the pair of substrates is obtained by dividing a base substrate having a size larger than a size of the display device which is finally obtained, and
one substrate out of the pair of substrates is a counter substrate which forms a transparent conductive film on an outer surface thereof and bears a trace which is formed by mechanical scribing on a divided periphery thereof, and another substrate is a thin film transistor substrate and bears a trace formed by cutting using a laser beam on a divided periphery thereof.

7. A display device according to claim 6, wherein the one substrate is a substrate on a viewer side.

8. A manufacturing method of a display device which is constituted of a pair of substrates which face each other in an opposed manner, the manufacturing method comprising the steps of:
obtaining the pair of substrates by dividing a base substrate having a size larger than a size of the display device which is finally obtained;
breaking one substrate out of the pair of substrates after applying the mechanical scribing to the one substrate; and
cutting another substrate using a laser beam thus dividing the base substrate into the individual display device size.

9. A manufacturing method of a display device according to claim 8, wherein the mechanical scribing applied to the one substrate and the cutting using the laser beam applied to the another substrate are performed without turning over the pair of substrates.

10. A manufacturing method of a display device according to claim 8, wherein the one substrate is mechanically broken.

11. A manufacturing method of a display device according to claim 8, wherein one substrate is broken using a laser.

12. A manufacturing method of a display device according to claim 8, wherein the mechanical scribing is applied to the one substrate in a state that a film is formed on an outer surface of the one substrate.

13. A manufacturing method of a display device according to claim 12, wherein the film is a transparent conductive film.

14. A manufacturing method of a display device according to claim 8, wherein the laser beam is a CO₂ laser or a YAG laser.

15. A manufacturing method of a display device according to claim 8, wherein the another substrate is a thin film transistor substrate, and the one substrate is a counter substrate.

16. A manufacturing method of a display device which includes one substrate and another substrate which face each other in an opposed manner, the manufacturing method comprising the steps of:
forming a film on an outer surface of the one substrate which is a surface opposite to a surface which faces the anther substrate;
applying a mechanical scribing to the one substrate from above the film formed on the outer surface; and
applying a cutting using a laser beam to the another substrate.

17. A manufacturing method of a display device according to claim 16, wherein the film formed on the outer surface of the one substrate is a transparent conductive film.

18. A manufacturing method of a display device according to claim 16, wherein the laser beam is a CO₂ laser.

19. A manufacturing method of a display device according to claim 16, wherein the film formed on the outer surface of the one substrate is a film which reflects the laser beam thereon.
